(19) United States
(12) Patent Application Publication
(10) Pub. No.: US 2018/0081430 A1
(43) Pub. Date: Mar. 22, 2018

(54) HYBRID COMPUTER INTERFACE SYSTEM

(71) Applicant: Sean William Konz, High Falls, NY (US)

(72) Inventor: Sean William Konz, High Falls, NY (US)

(21) Appl. No.: 15/268,543

(22) Filed: Sep. 17, 2016

(51) Int. Cl. G06F 3/01; G06F 3/0484

(52) U.S. Cl. CPC G06F 3/013; G06F 3/015; G06F 3/04842

(57) ABSTRACT

A hybrid system is used to perform screen object manipulation and or external device control. In a first portion of the hybrid system a single camera is used to provide the tracking of a user's pupil. In a second portion of the hybrid system an EEG device is used to detect brain waves (EEG signals) and use them to control the on-screen display or one or more external devices. The present invention is particularly useful for handicapped and disabled individuals.

### TECHNICAL FIELD

The present invention is generally directed to a computer interface system. More particularly, the present invention is directed to a hybrid eye-tracking and Electroencephalogram based human computer interface system which uses information from an image of an eye and a user's brainwaves to remotely interact with a computing system.

### BACKGROUND OF THE INVENTION

In recent years, computer interactions have become increasingly important parts of people's everyday lives. Many of these interactions are now mediated by computer interface technologies that facilitate direct communication between humans and computers (Liao et al., 2012). As computers have continued to develop, interface technologies have followed suit. They have become more efficient, more user friendly, and more capable of easing the barrier between human and machine.

Consequently, a considerable amount of research has focused on development of such computer interface systems. One type of system being explored for human-computer interfaces (HCIs) utilizes eye tracking software (Bohme et al., 2006). These systems function by locating a user's eye from an image and tracking that user's pupil motion for use in cursor control. This mechanism, while it has the benefit of being noninvasive and hands free, has limitations due to hardware and software capabilities that include the inability to maintain constant cursor control due to low resolution images, processing limitations, and inherent and involuntary pupil and head motions (Hansen, 2010). Previous studies have used additional hardware and other techniques in an attempt to overcome such difficulties. For example, Reulen et al. (1998) appear to have achieved accurate gaze tracking using head mounted infrared (IR) light emitting diodes (LEDs) and infrared sensitive photo-transistors above and below the eyes in order to measure the angular deviation of the eye. Cornsweet and Crane (1973) appear to have developed a gaze tracking system which measures the change in separation of the first and fourth Purkinje images to calculate the angular orientation of the eye. Gwon et al. (2014) appear to have used four illuminator lights on the corners of a display in order to calculate the center of a user's eye. This technique proves useful in tracking a user's eye movements in the presence of glasses. Multiple commercialized gaze trackers are available (e.g., Tobii gaze tracking solutions). Tobii gaze tracking uses IR emitters to produce a reflection upon the eye to allow accurate gaze tracking (Tobii, 2015). These systems employ expensive hardware and are more intrusive to use. Additionally, gaze tracking systems appear to have been developed without using precise x and y coordinates. Fu and Huang (2007) developed a method to detect head movement for cursor control with substantial success and Henessey et al. (2006) uses a single high resolution camera to track the gaze of a user with accuracies less than one degree of visual angle. This particular work demonstrates a gaze tracker based mainly on software components which is a significant improvement over hardware based gaze tracking systems. The eye trackers noted above demonstrate various techniques for accurate gaze and pupil estimation using advanced eye tracking based HCIs. However, they suffer from high computational complexity and/or expensive hardware requirements. Consequently, accurate eye tracking methods involving cursor control using a webcam are needed for affordable, efficient eye tracking based HCIs.

Brain-computer interfaces (BCIs) are another technology that has been highly researched for use in cursor control. Electroencephalograms (EEGs) have become a major source for BCI research initiatives (Morshed, 2014). Research in EEG-based consumer and research products has increased recently due to recent advancements in low power, wearable embedded systems technology and cyber-physical systems (Tan, 2010; Sanchez 2007; Debener et al., 2012; and Lee, 2008). By analyzing brainwave rhythms, a system can be developed to convert a user's brain impulses into image motion (Klimesch, 1999). Many different attempts have been made to develop EEG based BCIs that have resulted in varying degrees of success. Liao et al. (2012) gives a review of current techniques for EEG based BCI systems. These systems range from medical applications to everyday use. Jiang et al. (2014) describes a BCI device which uses a selection mechanism based on motor imagery induced EEG signals. This design demonstrates a simple means to extract data from EEG signals in a low complexity manor. These systems demonstrate the potential of BCI devices, but the use of large arrays of electrodes in order to extract brainwave values from the user are not desirable for most applications. Thus, an HCl device is needed which can efficiently combine the benefits of both eye tracking and EEG based interface systems.

### OTHER PUBLICATIONS

Bohme, M., Meyer, A., Martinetz, T., and Barth, E. (2006). “Remote eye tracking: State of the art and directions for future development. In Proceedings of the 2nd COGAIN, pages 10-15, Turin, Italy.
Cornsweet, T., H. Crane, Accurate two-dimensional eye tracker using first and fourth purkinje images, J. Opt. Soc. Am. 63 (8) (1973) 921-928.
Debener S, Minow F, Emkes R, Gandras K, Maarten de Vos (2012) How about taking a low-cost, small, and wireless EEG for a walk?, Psychophysiology 49: 1617-1621.
Gwon, S., Cho, C., Lee, H., Lee, W., & Park, K. (2014). Gaze Tracking System for User Wearing Glasses. Sensors, 14(2110-2134), 2110-2134.
Hansen, D., & Ji, Q. (2010). In the Eye of the Beholder: A Survey of Models for Eyes and Gaze. IEEE Transactions on Pattern Analysis and Machine Intelligence IEEE Trans. Pattern Anal. Mach. Intell., 478-500.
Hennessey, C., Noureddin, B., & Lawrence, P. (2006). A single camera eye-gaze tracking system with free head motion. Proceedings of the 2006 Symposium on Eye Tracking Research & Applications—ETRA '06.
Jiang, J., Zhou, Z., Yin, E., Yu, Y., & Hu, D. (2014). Hybrid Brain-Computer Interface (BCI) based on the EEG and EOG signals. Bio-Medical Materials and Engineering, 24, 2919-2925-2919-2925.
Klimesch, W. (1999). EEG alpha and theta oscillations reflect cognitive and memory performance: A review and analysis. Brain Research Reviews, 169-195.
Lee E A (2008) Cyber Physical Systems: Design Challenges: 363-369.
Liao, L., Lin, C., Mcdowell, K., Wickenden, A., Gramann, K., Jung, T., . . . Chang, J. (2012). Biosensor Technologies for Augmented Brain—Computer Interfaces in the Next Decades. Proceedings of the IEEE Proc. IEEE, 1553-1566.
Morshed, B. (2014). A Brief Review of Brain Signal Monitoring Technologies for BCI Applications: Challenges and Prospects. Journal of Bioengineering & Biomedical Science J Bioeng Biomed Sci.
Reulen, J., J. T. Marcus, D. Koops, F. de Vries, G. Tiesinga, K. Boshuizen, J. Bos, Precise recording of eye movement: the iris technique, part 1, Med. Biol. Eng. Comput. 26 (1) (1988) 20-26.
Sanchez J C, Principe J C (2007) Brain machine interface engineering, Morgan & Claypool Publishers: N Y, USA. Tan D S, Nijholt A (2010) Brain-computer interfaces, Springer: N Y, USA. Tobii X120 Eye Tracker: Technology that works in harmony with natural human behavior. (2015). Retrieved Sep. 21, 2015.
Fu, Y., & Huang, T. (n.d.). HMouse: Head Tracking Driven Virtual Computer Mouse. 2007 IEEE Workshop on Applications of Computer Vision (WAC V '07).

From the above, it is therefore seen that there exists a need in the art to overcome the deficiencies and limitations described herein and above.

### SUMMARY OF THE INVENTION

The shortcomings of the prior art are overcome and additional advantages are provided through the development of a hybrid interface system utilizing both electroencephalogram and eye tracking technologies.

In accordance with one embodiment of the present invention it comprises an apparatus for user interaction with a display screen. The apparatus includes an imaging device for capturing an image of the pupils in a user's eyes. There's also included an apparatus for measuring the brainwave activity of the user occurring within a predetermined frequency band. Electrode placement is selected based upon locations associated with certain brainwave activity. The invention also includes a stored program in a data processing device for: (1) the initial location detection of the user's pupils; (2) the detection of eye pupil movement; (3) analyzing the measured brainwave activity; and (4) controlling image information present on the display screen in response both to said pupil movement and to said brainwave activity.

In accordance with the embodiment described immediately above, typical utilization involves the movement of a cursor or mouse pointer using eye motion. User action is completed by an activity such as blinking to select the icon/item on which the indicator symbol comes to rest thus accomplishing a clicking motion.

In yet another embodiment of the present invention, rather than controlling a cursor, mouse pointer or similar indicator, the invention may be employed to control an external device. This environment is particularly useful for individuals having motor reflex disabilities.

In another aspect, the present invention provides remote computer interaction systems utilizing inherent bodily functions of a user paired with a hybrid design.

Accordingly, it is an object of the present invention to provide a hybrid HCl which combines the benefits of EEG and eye tracking-based systems into a single, affordable, efficient and easy to use interface device, which overcomes the aforementioned drawbacks.

The present hybrid design is obtained through a concurrent dual-system process utilizing an electroencephalogram and a pupil localization system in which: a user's pupil is detected using image processing techniques on a single webcam image feed and a user's selection attempt is detected through analysis of brainwave measurements associated with a user's blink or alternative selection action or thought process.

Furthermore, the electroencephalogram electrodes can be placed in varied locations to trigger a selection event according to a given user action or thought.

It is another object of the present invention to demonstrate a hybrid interaction system triggered using varied placements of EEG electrodes.

It is also an object to reduce computational complexity and to avoid image-based blink detection by using an electroencephalogram selection technique in conjunction with the calculations associated with a selection detection, thus resulting in a much faster, robust, and inexpensive option as compared with known systems.

Furthermore, expanded electroencephalogram support is usable to develop robust computational actions, virtual keystrokes, selection and activation mechanisms.

It is yet another object of the present invention to demonstrate an object motion control mechanism based on image processing manipulations conducted on images recorded by a single, low-resolution camera in variable lighting environments.

Furthermore, if adequate supporting information is available and extracted from an input image, a user's gaze can be determined and used to generate object motion.

Additionally, since no calibration of the camera or electroencephalogram is needed, the resulting systems demonstrates a more flexible and user-friendly system.

Furthermore, since ambient environment has a negligible effect on system performance, the invention is useful for diverse computing interaction applications.

The invention further includes a computer-readable medium having stored therein instructions for causing a processing unit to execute a method according to the above.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram illustrating the components of the present invention;

FIG. 2 Illustrates the circuit diagram of the of the electroencephalogram portion of the present invention;

FIG. 3 Illustrates electroencephalogram electrode placements on a user;

FIG. 4 Illustrates control program flow for the electroencephalogram component of the present invention;

FIG. 5 Illustrates the control program flow for the pupil localization component of the present invention;

FIG. 6 Illustrates the control program flow for the cursor control system based on pupil localization;

FIG. 7 Illustrates facial and eye regions accompanied by pupil locations which are determined on an input image to the pupil localization program;

FIG. 8 Illustrates the pupil and the center reference location on an eye, these locations demonstrating resting gaze locations,

FIG. 9 Illustrates the center reference location, the current pupil locations, and the corresponding distance from the central resting gaze location.

### DETAILED DESCRIPTION

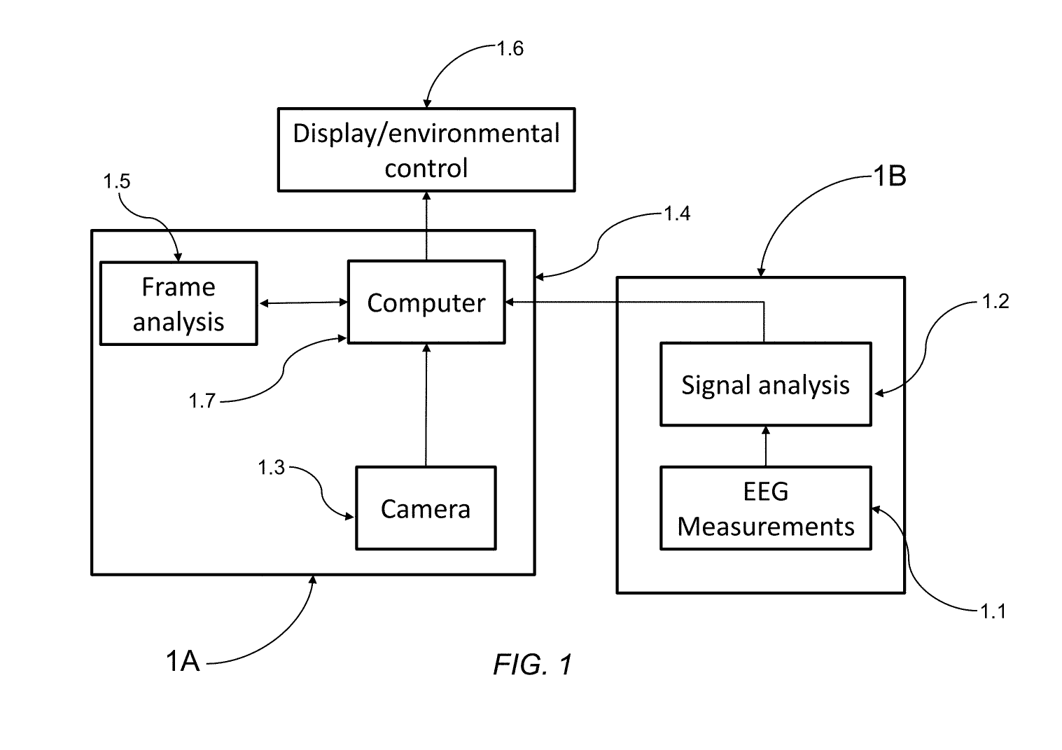

In FIG. 1 the structure of the hybrid system according to the present invention is illustrated. Independent components of the full system are shown in FIGS. 1A and 1B respectively. FIG. 1A illustrates components associated with the image processing and object motion data generation component system, while FIG. 1B illustrates components associated with the EEG activation mechanism component system.

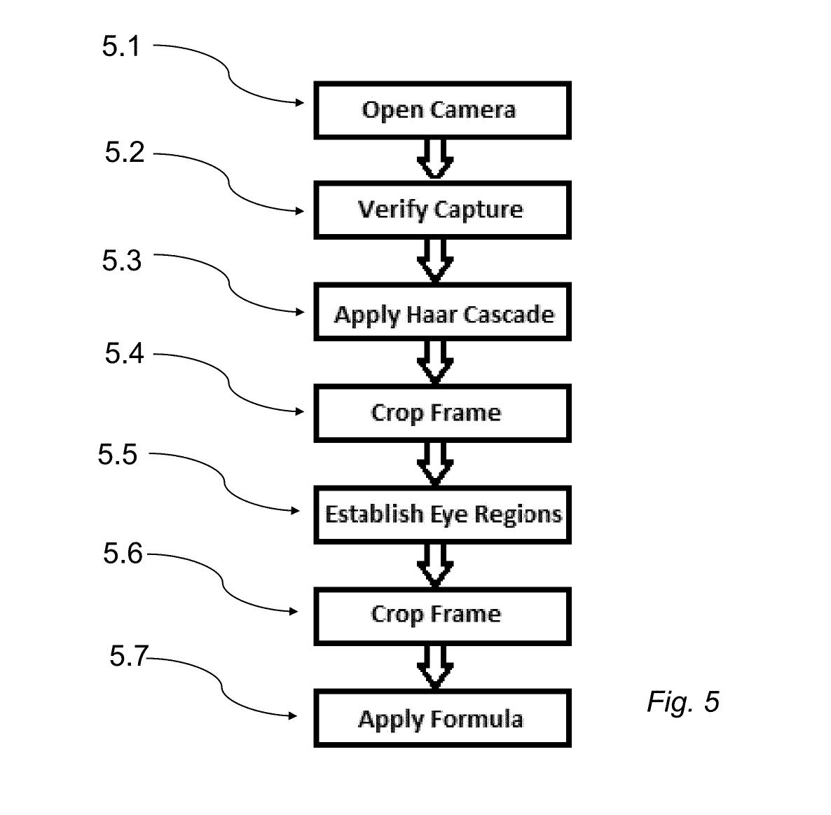

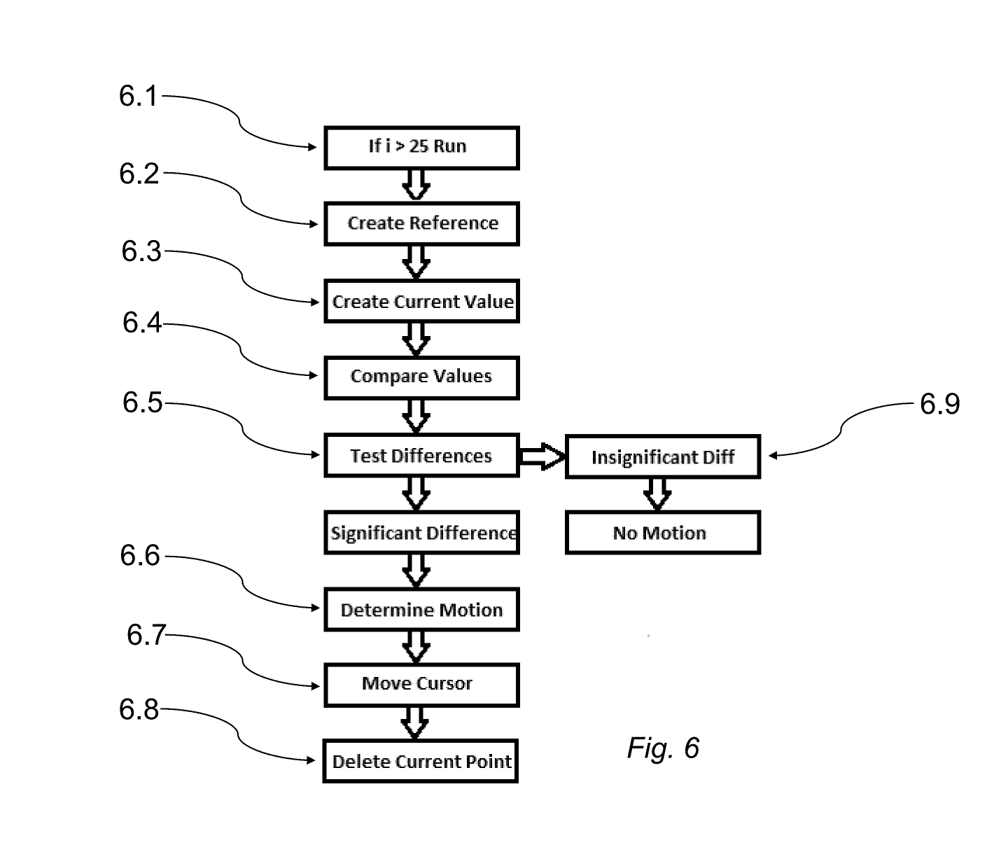

As illustrated in FIG. 1A, image processing and frame analysis is handled by the computer (or other competent data processing device) of the system. FIGS. 5 and 6 both illustrate independent processing steps employed in the analysis of input images from the camera feed, and the consequent object motion control logic. The present invention is particularly economical, simple and efficient in that it is usable with only a single camera.

Measurements from at least one eye are important for providing object motion control, and if a user moves his/her head swiftly, then the other eye can be used. Based on the shape of the eye and consistency of pupil localization attempts, it is possible to select the optimal eye for motion control throughout system operation. Object motion control based on both eyes leads to more robust pupil tracking.

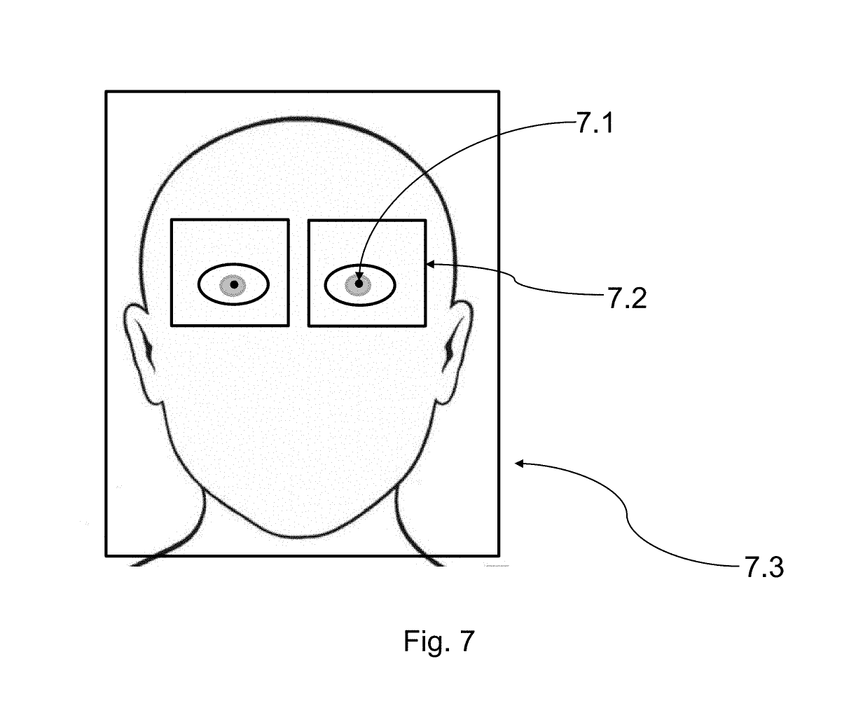

Steps 5.1 through 5.7 in FIG. 5 illustrate the pupil localization process associated with the present system. Captured frames are grabbed for analysis using a single input camera as shown in steps 5.1 and 5.2. Subsequent frames are cropped from the initial input frame based on the user's facial and eye regions. Facial regions of a user are calculated using a variety of techniques, the most common being Haar feature-based cascade classifiers to locate a facial region as noted in step 5.3 and illustrated in step 7.3 in FIG. 7.

Steps 5.4, 5.5, and 5.6 in FIG. 5 denote processing steps useful in improving the accuracy of the pupil localization process. Reference numeral 7.2 in FIG. 7 illustrates such eye regions on a user. By cropping the frame to regions with a higher likelihood of actual pupil location, the processing steps and speed of the system is significantly improved. Eye regions are computed through similar feature cascades as used for facial region recognition, but a computationally simpler method is employed by using predefined dimensional percentages to calculate general eye regions based on a defined facial region.

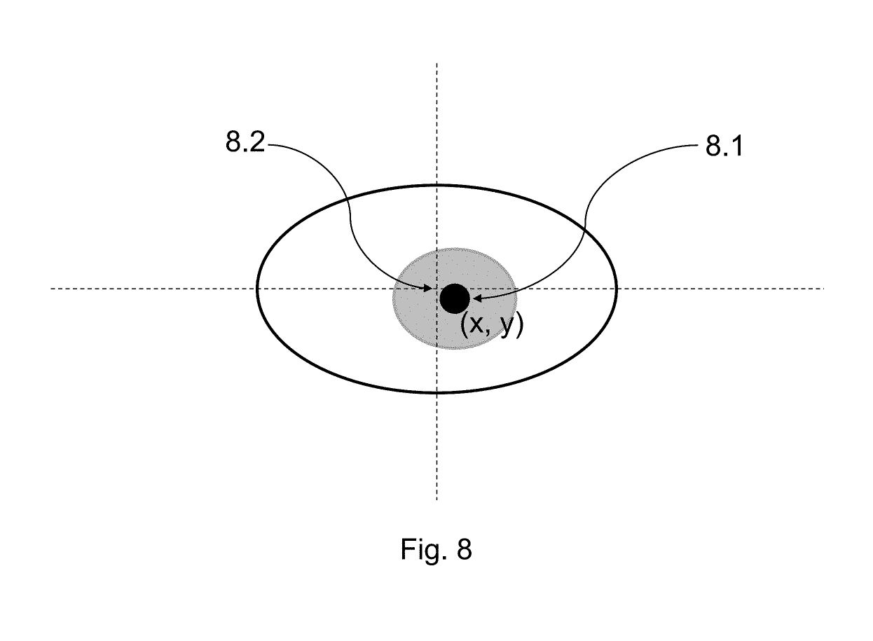

The final pupil localization step includes a recognition of a precise (x, y) coordinate location of a user's pupil through mathematical manipulation of image characteristics and is illustrated in FIG. 7 and as a precise location in FIG. 8.

FIG. 6 illustrates subsequent processing steps used to develop object motion after pupil location is determined in any given frame. The logic diagram illustrates potential decisions for system operation.

Suggested logic flow for pupil based object motion control is detailed as followed, but does not limit the scope of the potential logic flow to achieve a similar outcome for the implementation of the invention:

Step 6.1 in FIG. 6 illustrates a logic gate which delays operation of the system until a specified number of frames have been recorded, for example, 25 as shown. These frames are employed to generate reference and current values shown in steps 6.2 and 6.3 respectively.

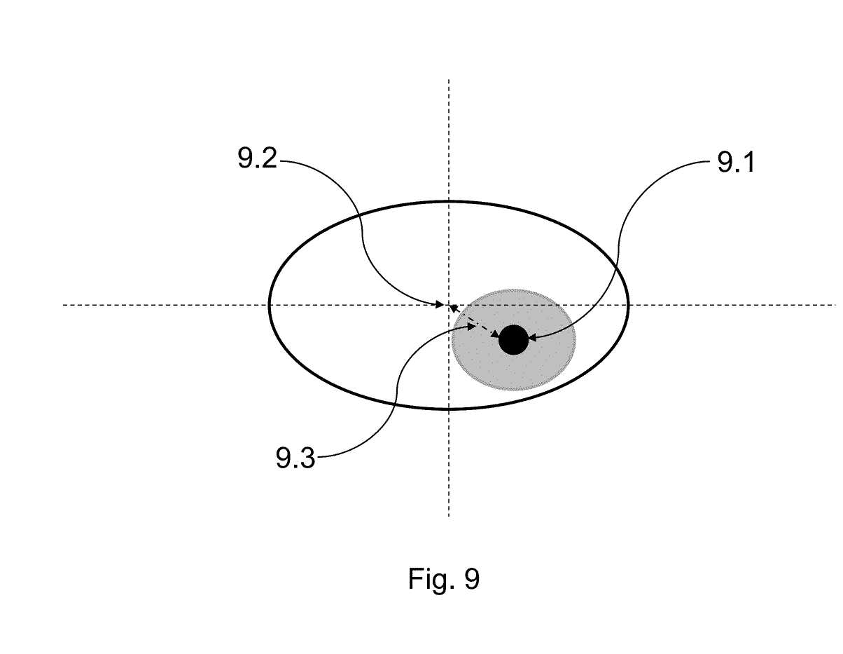

The reference and current values of 6.2 and 6.3 respectively refer to pupil locations as illustrated in FIGS. 8 and 9.

FIG. 8 illustrates both a precise pupil location (8.1) and an average resting center value (8.2). The average resting center value is the mean central region of the user's pupil when centered at rest, and is used as the reference value mentioned in step 6.2.

FIG. 9 illustrates an altered pupil location (9.1) with significant distance (9.3) from the mean central region, or reference value (9.2).

The values generated in steps 6.2 and 6.3 are compared, as illustrated in step 6.4, and their result is used in the logic branch at step 6.5.

A significant difference in values from steps 6.2 and 6.3, illustrated by the distance represented by 9.3 in FIG. 9, generates desired motion determination in step 6.6, a subsequent motion of the cursor in step 6.7, and desired system maintenance steps at step 6.8.

An insignificant difference in values from steps 6.2 and 6.3 results in no object motion and a repetition of the process.

The process repeats indefinitely, or until system termination.

The suggested logic flow for object motion determination based on pupil motion demonstrates a single option for the invention's operation.

FIG. 1B illustrates the electroencephalogram portion of the present invention. The electroencephalogram system component provides an alternative input mechanism which decreases computational complexity, and overall cost of the system. Furthermore, the addition of the electroencephalogram provides an added dimension of functionality for the system.

FIG. 1B illustrates the fact that EEG measurements are recorded (1.1), analyzed (1.2) and sent to system control computer 1.7. The electroencephalogram measurements are not limited to a single channel design, and in fact can be expanded to incorporate increased numbers of electrodes and electroencephalogram measurements to develop a more robust key or action activation mechanism.

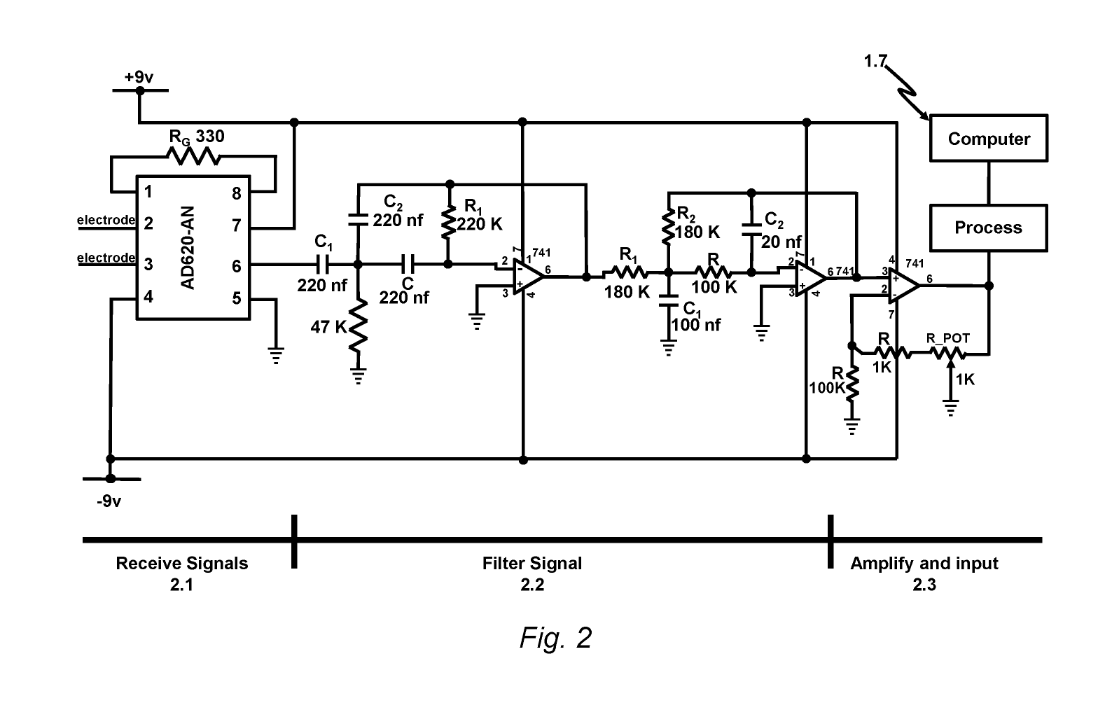

EEG measurements 1.1 noted in FIG. 1 and subsequent signal processing steps noted in block 1.2 in FIG. 1 are recorded through the use of an electroencephalogram machine, illustrated in FIG. 2, comprising the following components: (1) a signal input mechanism, or a method for a circuit to receive an electrical signal from a user, an example of such circuitry is illustrated in portion 2.1 of FIG. 2; (2) a signal filtration stage, illustrated in portion 2.2 of FIG. 2, such that the input electrical signal is tuned to a specified frequency range according to the desired activation mechanism method, whether it be a mental or physical process; and (3) an amplification and input stage, illustrated in portion 2.3 of FIG. 2, such that the received electrical signal is converted from an analog signal to a digital value, analyzed to determine if an activation attempt was conducted by the user, and the resulting value, representing the desired action from the user, is input to the system control computer 1.7.

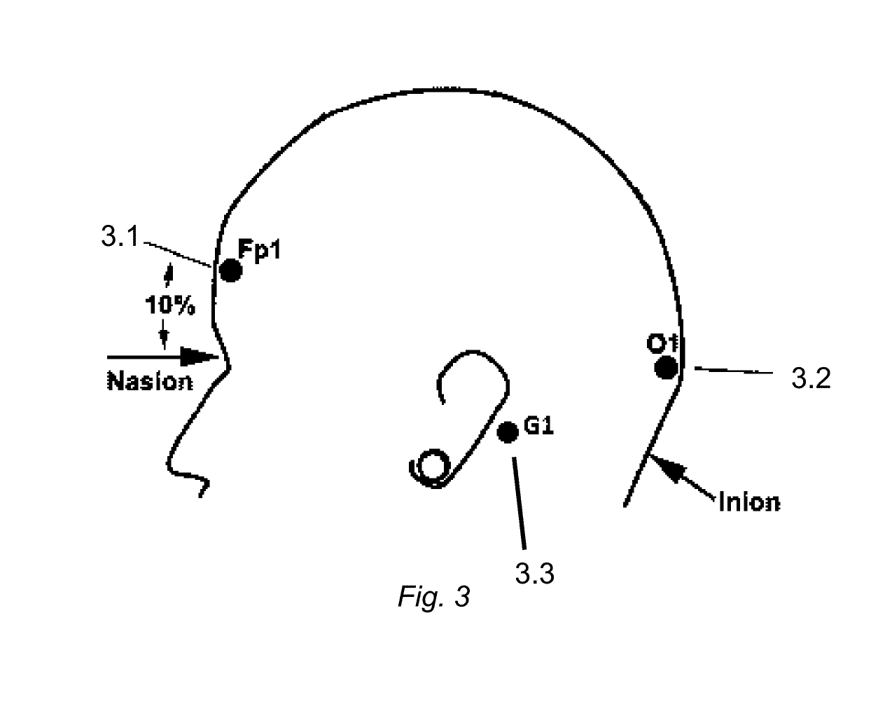

Potential electroencephalogram electrode placements are illustrated in FIG. 3, albeit electrode placements are not limited to these locations. These illustrated electrode placements are such that a user's alpha wave brainwaves (frequencies of 8 Hz to 22 Hz) are measured from the frontal parietal lobe (Fp1 or reference numeral 3.1) and the occipital lobe (O1 or reference numeral 3.2). The alpha wave frequency band at these locations is an indicator of user relaxation and a spike in the frequency band is observed when a user “blinks” their eyes. Electrode location 3.3 is a ground reference electrode. The specified locations shown as locations 3.1 and 3.2 demonstrate merely one electrode placement scheme for system operation.

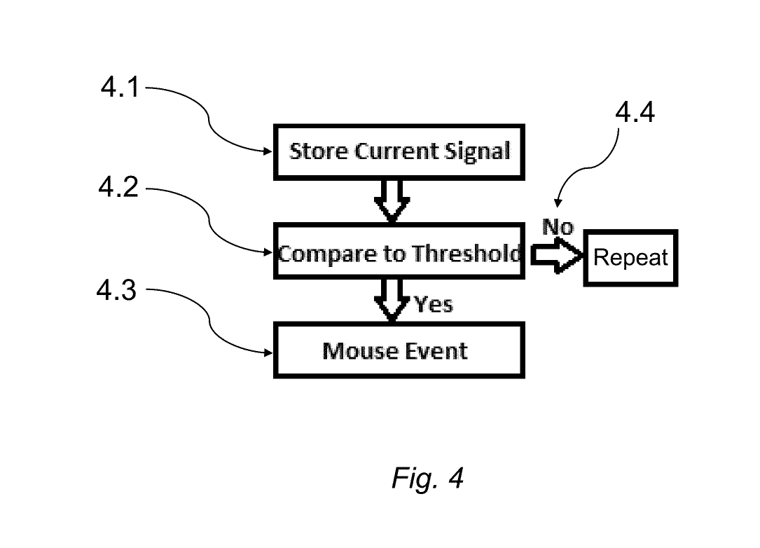

Additionally, FIG. 4 illustrates one embodiment of a possible logic flow for the system component responsible for the activation mechanism, but does not limit the invention to the illustrated logic flow diagram. The illustrated logic flow follows a single decision mechanism functioning as a switch at step 4.2. The stored signal from step 4.1 is compared to a predefined threshold value in step 4.2. If the current value (step 4.1) is greater than the stored threshold, a signal is relayed to control computer 1.7 specifying the desired event from the user resulting in a mouse event or alternative activation mechanism event in the form of a keystroke event, or alternative computational process (step 4.3).

If the stored signal from step 4.1 is below the predefined threshold, control passes to step 4.4 and the loop repeats.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC § 112, sixth paragraph, unless the element is expressly recited using the phrase “means for.”

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

1. An apparatus for user interaction with a display screen, said user having at least one eye and a pupil therein, said apparatus comprising:
an imaging device for capturing an image of said at least one pupil in said at least one eye of said user;
an apparatus for measuring brainwave activity in said user within a predetermined frequency band and with electrode placement associated with predetermined brainwave activity; and
a non-transitory computer readable medium having stored instructions for causing a data processing device to execute: (1) initial detection of said pupil location; (2) detection of movement of said pupil; (3) analysis of said brainwave activity to determine voluntary eye blinking; and (4) clicking on image information present on said display screen in response both to said pupil movement and to said brainwave activity.

2. An apparatus for user interaction with an external device, said user having at least one eye and a pupil therein, said apparatus comprising:
an imaging device for capturing an image of said at least one pupil in said at least one eye of said user;
an apparatus for measuring brainwave activity of said user within a predetermined frequency band and with electrode placement associated with predetermined brainwave activity; and
a non-transitory computer readable medium having stored instructions for causing a data processing device to execute: (1) initial detection of said pupil location; (2) detection of movement of said pupil; (3) analysis of said brainwave activity to determine voluntary eye blinking; and (4) interaction with said external device in response both to said pupil movement and to said brainwave activity.

3. A system for developing human interaction with a computational device or as a mode for real world interaction, said user having at least one eye and a pupil therein said system implementing a hybrid design comprising:
means for detecting the position of the pupil of at least one eye;
means for tracking said position through a series of frames from an input video feed;
means for determining position to develop object motion across a planar coordinate system for a display device;
means for concurrently measuring brainwaves of a user associated with a specified frequency band with electrode placements associated with voluntary eye blinking; and
means for coordinating said brainwave measurements into an activation event for a specified computational application.

4. An apparatus for interaction by a user with a display screen, said apparatus comprising:
an imaging device for capturing an image of a pupil in an eye of said user;
a data processing device for determining the location of said pupil and associating said location with a corresponding point on said display;
a brainwave measurer for a predetermined brainwave frequency band; and
stored programming within said data processing device for distinguishing involuntary eye blinking from voluntary eye blinking and for clicking on said corresponding point on said display in response to detection of said voluntary blinking.
